(19) United States
(12) Patent Application Publication
(10) Pub. No.: US 2011/0188582 A1
(43) Pub. Date: Aug. 4, 2011

(54) PIXEL BASED THREE-DIMENSIONAL ENCODING METHOD

(75) Inventor: William Pat Price, Keller, TX (US)

(73) Assignee: VIZIO INC., Irvine, CA (US)

(21) Appl. No.: 12/697,313

(22) Filed: Feb. 1, 2010

(51) Int. Cl. H04N 7/12; H04N 13/00

(52) U.S. Cl. 375/240.26; 375/E07.076; 348/42; 348/E13.001

(57) ABSTRACT

An application for three-dimensional encoding of frames of a digital video includes reserving a subset of pixels of each frame of the digital video and encoding frames meant for a first eye with a first pattern and encoding frames meant for the second eye with a second pattern, the second pattern being detectably different than the first pattern. Optionally, for frames having content for both eyes, any other pattern that is detectably different from the first pattern or second pattern is encoded into the subset of pixels. The subset of pixels is used during playback to shutter the left-eye and right-eye to simulate three-dimensions.

### CROSS-REFERENCE TO RELATED APPLICATION

This application is related to U.S. patent application titled “PIXEL SYSTEM, METHOD AND APPARATUS FOR SYNCHRONIZING THREE-DIMENSIONAL EYEWEAR,” attorney docket 10.0001 filed even date here within. This application is also related to U.S. patent application titled “FRAME SYSTEM, METHOD AND APPARATUS FOR SYNCHRONIZING THREE-DIMENSIONAL EYEWEAR,” attorney docket 10.0002 filed even date here within. This application is also related to U.S. patent application titled “FRAME BASED THREE-DIMENSIONAL ENCODING METHOD,” attorney docket 10.0004 filed even date here within.

### FIELD

This invention relates to the field of display devices worn over an individual's eyes and more particularly to a system for synchronizing the display devices with content presented on a display screen.

### BACKGROUND

There are several ways to present a three-dimensional image to a viewer of a television. The common aspect of the existing methods is to present an image or frame from two perspectives, a left-eye perspective of the content to the left eye and present an image or frame from a right-eye perspective to the right eye. This creates the proper parallax so that the viewer sees both perspectives and interprets what they are seeing as three-dimensional.

Early three-dimensional content was captured using two separate cameras aimed at the subject but slightly separate from each other providing two different perspectives. This simulates what the left eye and right eye see. The cameras simultaneously exposed two films. Using three-dimensional eyewear, the viewer looks through one film with the left eye and the other film with the right eye, thereby seeing what looks like a three-dimensional image.

Progressing to motion pictures, three-dimensional movies were produced in a similar way with two cameras, but the resulting images were color encoded into the final film. To watch the film in three-dimension, eyewear with colored filters in either eye separate the appropriate images by canceling out the filter color. This process is capable of presenting a three-dimensional movie simultaneously to a large audience, but has marginal quality and, because several colors are filtered from the content, results in poor color quality, similar to a black and white movie.

More recently, personal headsets have been made that have two separate miniature displays, one for each eye. In such, left content is presented on the display viewed by the left eye and right content is presented on the display viewed by the right eye. Such systems work well, but require a complete display system for each viewer.

Similar to this, Eclipse methods uses a common display, such as a television, along with personal eyewear that have fast-response shutters over each eye. In such, the left eye shutter is open allowing light to pass, the right eye shutter is closed blocking light and the television displays left-eye content, therefore permitting the light (image) from the television to reach the left eye. This is alternated with closing of the left eye shutter, opening of the right eye shutter and displaying right-eye content the television. By alternating faster than the typical human response time, the display appears continuous and flicker-free.

The problem with the latter two methods is that the three-dimensional content must be encoded on, for example, a disk and decoded by a player that switches between left/right eye content in synchronization with the left-eye and right-eye shutter. With such, one cannot connect an industry standard player (e.g. BlueRay or DVD) to an industry standard television (e.g., Plasma or LCD television) and watch three-dimensional content with a set of three-dimensional eyewear.

What is needed is a three-dimensional presentation system that utilizes existing, industry standard media delivery devices and provides three-dimensional viewing.

### SUMMARY

Content is encoded such that a small portion of the displayable image/frame is used to encode an indicator of whether the current image/frame is intended for the left eye or intended for the right eye. In simplistic terms, one might imaging a box in the lower right corner of the image having either a ‘L’ or ‘R’; the ‘L’ displayed when the frame is intended for the left eye and the ‘R’ displayed when the frame is intended for the right eye. If the frames are displayed at a rate of, for example, one frame a second and the viewer alternates closing of the left eye when ‘R’ is displayed and the right eye when ‘L’ is displayed, the viewer would interpolate the image as a crude three-dimensional image.

As the frame rate increases from one frame per second to 30 frames per second, the image quality would improve, but the viewer would have difficulty blinking at such a fast rate. Instead, the viewer wears shutters over each eye that open and close fast enough to keep up with the frame rate and the shutters recognize the ‘L’ or ‘R’ to determine which eye should see the image on the display and which eye should not see the image on the display. In this system, the content is encoded, but is delivered in the same way, on the same media/transmission as existing two-dimensional content. The only addition needed to decode the three-dimensional images is the shutter system that recognizes the left-indication and right-indication and operates the shutters in synchronization with the appropriate indication. The following disclosure operates on this principle, using any of a number of disclosed and undisclosed left/right indicators and any of the disclosed and undisclosed shutter mechanisms. Various methods of transferring the left/right synchronization signal to the shutters are also disclosed.

In summary, content is encoded with a left/right frame indicator at a pre-determined location on each frame. A standard content delivery mechanism (e.g. Internet, cable, fiber-optic, DVD, BlueRay) delivers the content to a standard television. A detector is interfaced to the screen of the television to detect the left/right indication and provide synchronization to shutters of three-dimensional eyewear. During display frames meant for a first eye, the set of pixels contain a first pattern while during display of frames meant for the second eye, the set of pixels contain a second pattern. The detector is positioned over the set of pixels and determines which pattern is displayed, generating a synchronization signal based upon the patterns. The synchronization signal is then transmitted/transferred to the three-dimensional eyewear where it is used to properly shutter the first eye and the second eye. A phased-locked loop is provided within the three-dimensional eyewear to continue operation of the shutters during periods when the transmission of the synchronization signal is blocked or otherwise interrupted. The first pattern and second pattern are, for example, colors, patterns or brightness of the set of pixels. Since the frame rate is generally higher than human response, watching the content without three-dimensional eyewear results in a slightly blurry image since both eyes see the left frames alternating with the right frames. Without the three-dimensional eyewear, the left/right indicator area is a blend of the left indicator and right indicator. For example, if the left indicator is a red set of pixels and the right indicator is a blue set of pixels, a viewer without three-dimensional eyewear sees a purple set of pixels.

In one embodiment, a method of encoding three-dimensional digital video content is disclosed. The method includes reserving a subset of pixels of each digital video frame and encoding the subset of pixels with a first pattern of pixel values representing left-eye frames containing left-eye content and encoding the subset of pixels with a second pattern of pixel values representing right-eye frames containing right-eye content.

In another embodiment, a method of encoding digital content with three-dimensional indicators is disclosed. The method includes (a) reserving a predetermined set of pixels of each frame of the digital content for three-dimensional encoding. Next, (b) while more frames exist in an input stream: (c) reading a current frame; (d) if the current frame is a left-eye frame, encoding the predetermined set of pixels with a first set of pixel values and (e) if the current frame is a left-eye frame, encoding the predetermined set of pixels with a second set of pixel values. The second set of pixel values being detectably different than the first set of pixel values. After encoding, (f) writing the current frame to an output stream.

In another embodiment, a three-dimensional encoding of digital video content is disclosed including, providing a sequence of frames on a digital media, each frame containing pixels, a subset of pixels reserved for encoding. In frames having left-eye content, the subset of pixels is encoded with a first set of pixel values and in frames having right-eye content, the subset of pixels is encoded with a second set of pixel values. The first set of pixel values is detectably different than the second set of pixel values.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a plan view of a television and three-dimensional eyewear of the prior art.

FIG. 2 illustrates a plan view of a television and a first embodiment of three-dimensional eyewear.

FIG. 3 illustrates a plan view of a television and a second embodiment of three-dimensional eyewear.

FIG. 4 illustrates a block diagram of a transmitter of the first embodiment of three-dimensional eyewear.

FIG. 5 illustrates a schematic view of a typical transmitter of the first embodiment of three-dimensional eyewear.

FIG. 6 illustrates a block diagram of a typical transmitter of the second embodiment of three-dimensional eyewear.

FIG. 7 illustrates a schematic view of a typical transmitter circuit of the second embodiment of three-dimensional eyewear.

FIG. 8 illustrates a schematic diagram of a typical receiver circuit of the first embodiment of three-dimensional eyewear.

FIG. 9 illustrates a schematic view of a typical receiver of the second embodiment of three-dimensional eyewear.

FIG. 10 illustrates a synchronization timing chart.

FIG. 11 illustrates a block diagram of a third embodiment.

FIG. 12 illustrates a block diagram of a fourth embodiment.

FIG. 13 illustrates a schematic diagram of the third embodiment.

FIG. 14 illustrates a schematic diagram of the fourth embodiment.

FIG. 15 illustrates a block diagram of a fifth embodiment.

FIG. 16 illustrates a schematic diagram of the fifth embodiment.

FIG. 17 illustrates a sequence of frames according to a first transmission arrangement.

FIG. 18 illustrates a sequence of frames according to a second transmission arrangement.

FIG. 19 illustrates an exemplary sequence of displayed frames according to a second transmission arrangement.

FIG. 20 illustrates a second exemplary sequence of displayed frames according to a second transmission arrangement.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures. The bezel of the present invention is the facing surface surrounding an image producing surface such as an LCD panel, CRT, Plasma panel, OLED panel and the like.

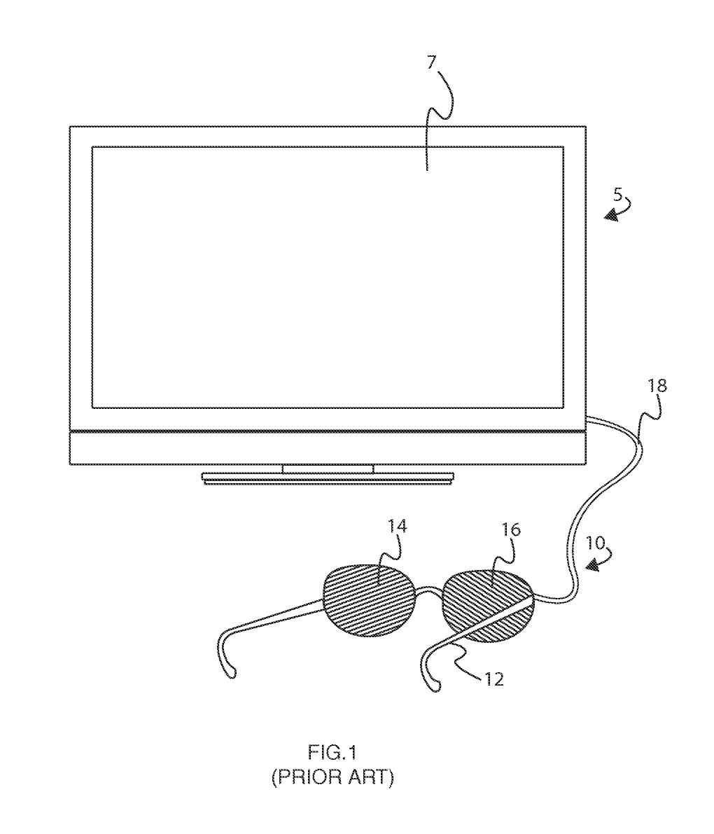

Referring to FIG. 1, a plan view of a television and three-dimensional eyewear of the prior art is described. In prior technology, three-dimensional eyewear 10 functioned with specialized content delivery hardware, such a personal computer or specially equipped television 5. The personal computer or television 5 displays three-dimensional content on a display 7 and controls the eyewear 10 through a cable 18 that provided control of each eye shutter 14/16, synchronizing the eye shutters 14/16 to the content being displayed on the display 7. The eyewear often includes frames with ear rests 12. In such systems, specialized content is usually required containing left-eye and right-eye encoded frames. Specialized hardware and/or software is also required in the personal computer or television 5 to properly display the content and synchronize operation of the left/right shutter with the display of the content.

It is advantageous to utilize existing content delivery mechanisms (e.g. Internet delivery, DVD disks, BlueRay disks, etc) and existing display technology (e.g. monitors, televisions, etc) without modification, The prior art does not provide for such.

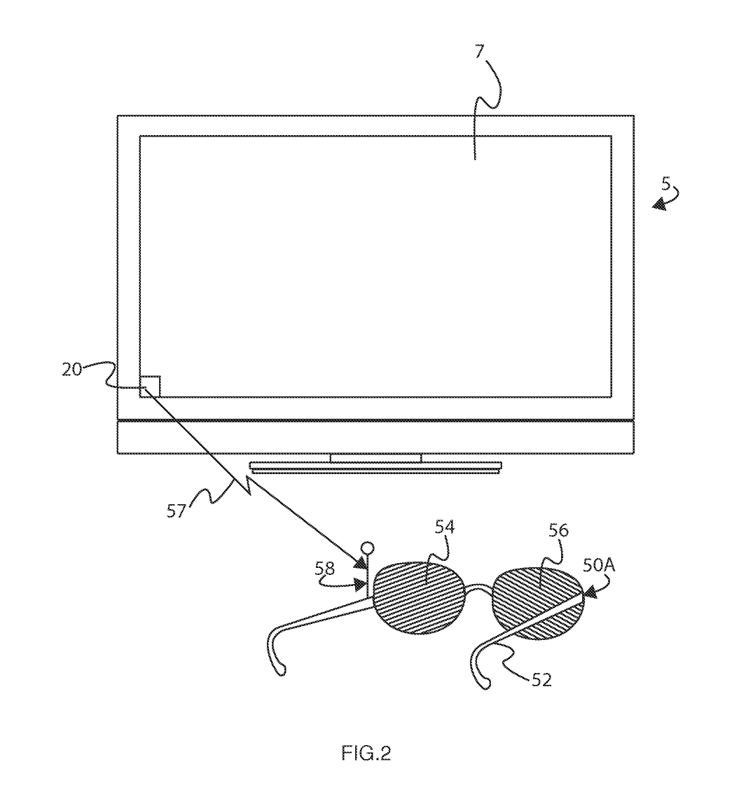

Referring to FIG. 2, a plan view of a display device (e.g. television) 5 and a first embodiment of three-dimensional eyewear 50A is described. In this, a transmitter device 20 is attached to cover a subset of the pixels of the display 7. As will be described, the transmitter 20 receives light from the subset of the pixels, detects a predetermined value of the light and generates a synchronization signal from the predetermined value of the light. The synchronization signal is transmitted to the three-dimensional eye wear 50A, in this example, by a radio frequency signal 57. For example, the synchronization signal is transmitted by a pre-determined frequency modulation, pulse code modulation, etc, as known in the industry. The radio frequency signal is received by an antenna 58 and decoded within the eyewear 50A or by an attached circuit to the eyewear 50A, controlling the eyewear shutters 54/56 as will be described. Note, in some embodiments, the eyewear 50A includes ear rests 52 for support.

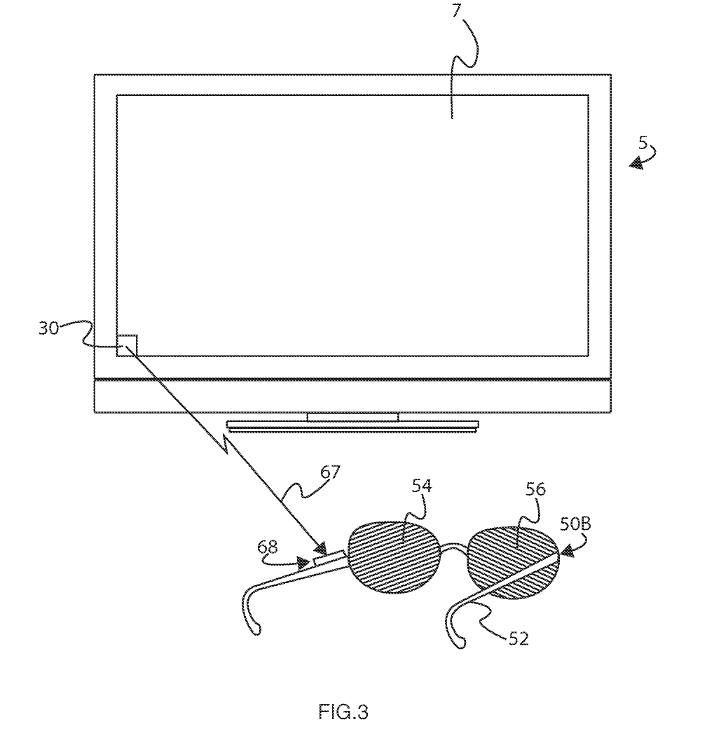

Referring to FIG. 3, a plan view of a television 5 and a second embodiment of three-dimensional eyewear 50B is described. In this, a transmitter device 30 is attached to cover a subset of the pixels of the display 7. As will be described, the transmitter 30 receives light from the subset of the pixels, detects a predetermined value of the light and generates a synchronization signal from the predetermined value of the light. The synchronization signal is transmitted to the three-dimensional eye wear 50B, in this example, by a light signal 67. For example, the synchronization signal is transmitted by a pre-determined modulated wavelength of light, preferably non-visible light such as Infra-red light, etc, as known in the industry. The modulated light signal 67 is received by a light detector 68 and decoded within the eyewear 50B or by an attached circuit to the eyewear 50B, controlling the eyewear shutters 54/56 as will be described. Note, in some embodiments, the eyewear 50B includes ear rests 52 for support

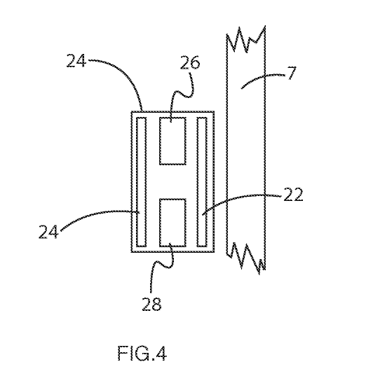

Referring to FIG. 4, a block diagram of a transmitter 20 of the first embodiment of three-dimensional eyewear 50A is described. The transmitter 20 has a light detector 22 that interfaces to the display 7 over an area of the predetermined subset of pixels that convey the left-eye/right-eye synchronization signal. The light detector 22 receives light from the display 7 and converts it into an electrical signal and presents the electrical signal to a detection circuit 26 that analyzes the electrical signal to determine which pre-determined light value is being displayed on the predetermined subset of pixels and generates a synchronization signal based upon such. There are many encoding values for the left/right eye synchronization signal into a subset of pixels such as a first color for left and a second color for right, a first series of pixel color values for left and a second series of pixel colors for right, etc. As an example, all of the subset of pixels is red for left-eye content and black for right-eye content. The detector 26 then receives a first value of electrical signal for red light and a second value of the electrical signal for black (absence of light).

The synchronization signal is then modulated for transmission, in this example, using radio frequencies over an antenna 24. The modulation is any known modulation scheme. For example, a simple modulation scheme includes a carrier frequency and a signal frequency, wherein a left-eye signal is transmitted as the carrier frequency and the right-eye signal is transmitted as the signal frequency. Alternately, the left-eye signal consists of a first sequence of carrier frequency alternating with signal frequency and the right-eye signal consists of a second sequence of carrier frequency alternating with signal frequency. There are many known methods of transmitting a signal over radio frequencies, all of which are included here within.

The transmitter 20 has either an internal power source 28 (such as a battery or rechargeable capacitor; or has an external power source such as a wall-wart/brick (not shown).

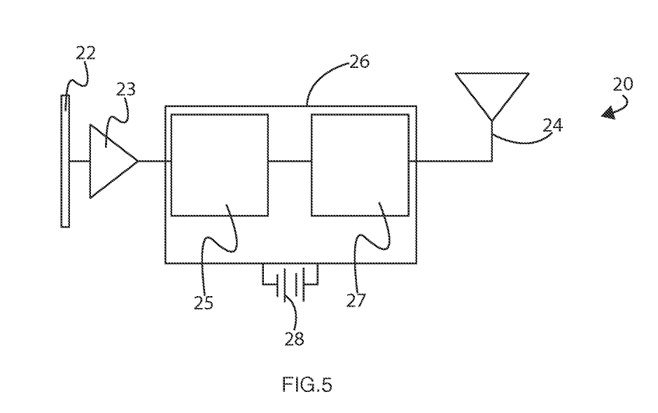

Referring to FIG. 5, a schematic view of a typical transmitter 20 of the first embodiment of three-dimensional eyewear system is described. The transmitter 20 has a light detector 22 that detects light from the display 7 and converts the light into an electrical signal which is amplified by an operational amplifier 23 and is presented to a detection circuit 26 that analyzes the electrical signal to determine which pre-determined light value is being displayed on the predetermined subset of pixels and generates a synchronization signal based upon such. The detection circuit has a decoder 25 that extracts the synchronization signal from the electrical signal. Any type of detection circuit is anticipated, including, but not limited to, counters, frequency high-pass and/or low-pass filters, etc. The synchronization signal is fed to a radio frequency modulator 27 that uses any known radio frequency modulation technique and the modulated radio frequency is transmitted by way of an antenna 24, which is preferable a solid-state, micro-miniature antenna, though any antenna is anticipated.

The transmitter is powered by a power source 28, as known in the industry, including, but not limited to batteries, rechargeable batteries, charged capacitors, wall bricks, etc. It is anticipated that the power source 28 be replaceable and/or rechargeable inside or outside of the transmitter 26. In some embodiments, light from the television display 7 is used to charge the power source 28.

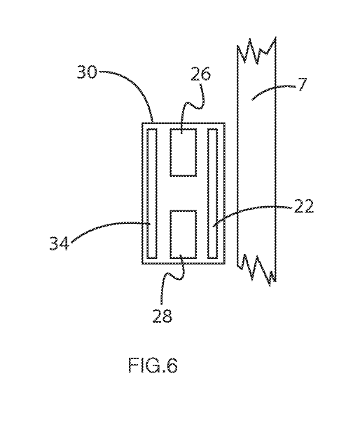

Referring to FIG. 6, a block diagram of a typical transmitter 30 of the second embodiment of three-dimensional eyewear is described. The transmitter 30 has a light detector 22 that interfaces to the display 7 over an area of the predetermined subset of pixels that convey the left-eye/right-eye synchronization signal. The light detector 22 receives light from the display 7 and converts it into an electrical signal and presents the electrical signal to a detection circuit 26 that analyzes the electrical signal to determine which pre-determined light value is being displayed on the predetermined subset of pixels and generates a synchronization signal based upon such. There are many encoding values for the left/right eye synchronization signal into a subset of pixels such as a first color for left and a second color for right, a first series of pixel color values for left and a second series of pixel colors for right, etc. As an example, all of the subset of pixels is red for left-eye content and black for right-eye content. The detector then receives one value of electrical signal for red light and a second value of the electrical signal for black (absence of light).

The synchronization signal is then modulated for transmission, in this example, using light waves emitted from a light output device 34 such as a light emitting diode (LED). The modulation is any known modulation scheme. For example, a simple modulation scheme includes modulation on/off of a light of a specific wavelength, preferably an invisible light such as infra-red light. In such, a left-eye signal is transmitted as a first on/off frequency or sequence of the light and the right-eye signal is transmitted as a second on/off frequency of the light. There are many known methods of transmitting a signal utilizing one or more wavelengths of light, all of which are included here within.

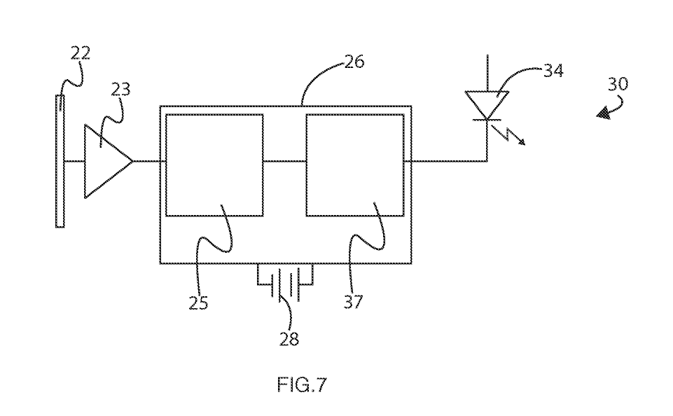

Referring to FIG. 7, a schematic view of a typical transmitter circuit of the second embodiment of three-dimensional eyewear system is described. The transmitter 20 has a light detector 22 that detects light from the display 7 and converts the light into an electrical signal which is amplified by an operational amplifier 23 and is presented to a detection circuit 26 that analyzes the electrical signal to determine which pre-determined light value is being displayed on the predetermined subset of pixels and generates a synchronization signal based upon such. The detection circuit has a decoder 25 that extracts the synchronization signal from the electrical signal. Any type of detection circuit is anticipated, including, but not limited to, counters, frequency high-pass and/or low-pass filters, etc. The synchronization signal is fed to a light modulator 37 that uses any known light modulation technique and the modulated light is transmitted by way of light output device 34 which is preferable a light emitting diode 34, though any suitable light output device is anticipated.

The transmitter is powered by a power source 28, as known in the industry, including, but not limited to batteries, rechargeable batteries, charged capacitors, wall bricks, etc. It is anticipated that the power source 28 be replaceable and/or rechargeable inside or outside of the transmitter 26. In some embodiments, light from the television display 7 is used to charge the power source 28.

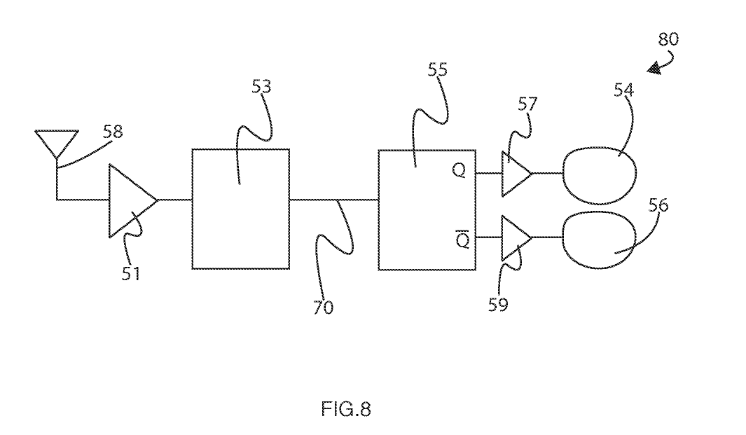

Referring to FIG. 8, a schematic diagram of a typical receiver circuit 80 of the first embodiment of three-dimensional eyewear 50A is described. In such, the radio frequency signal 57 is picked up by the antenna 58 and, optionally amplified by an operation amplifier 51 and detected/demodulated by a demodulator 53, recovering the transmitted synchronization signal 70. A timing circuit 55 translates the synchronization signal 70 into a left-eye (Q) control signal and a right-eye (−Q) and is coupled to the left-eye shutter 54 and right-eye shutter 56, respectively, by shutter drivers 57/59. In the preferred embodiment, the timing circuit 55 includes a phased-locked-loop that provides the left-eye and right-eye control signal during a loss of the shutter signal 70.

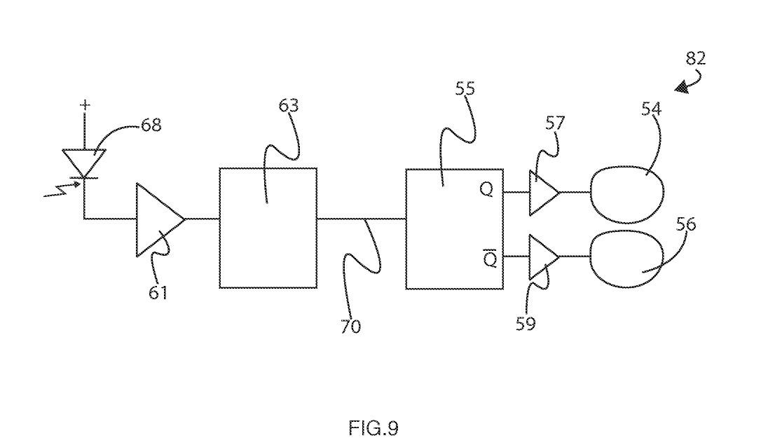

Referring to FIG. 9, a schematic view of a typical receiver 82 of the second embodiment of three-dimensional eyewear 50B is described. In such, the light signal 67 is picked up by a light detector 68 (e.g., photo diode 68) and, optionally amplified by an operation amplifier 61 and detected/demodulated by a demodulator 63, recovering the transmitted synchronization signal 70. A timing circuit 55 translates the synchronization signal 70 into a left-eye (Q) control signal and a right-eye (−Q) and is coupled to the left-eye shutter 54 and right-eye shutter 56, respectively, by shutter drivers 57/59. In the preferred embodiment, the timing circuit includes a phased-locked-loop that provides the left-eye and right-eye control signal during a loss of the shutter signal 70.

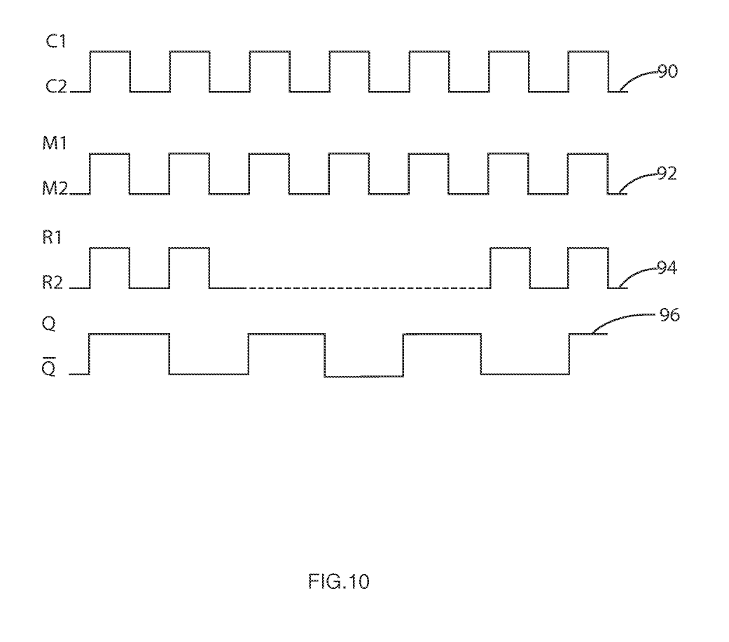

Referring to FIG. 10, an exemplary synchronization timing chart is described. In this example, the alternation of the eye shutters 54/56 is intended to occur during the leading edge transition. In other examples, the alternation is at the trailing edge or the open shutter 54/56 is dependent upon a specific signal level, frequency or voltage. It is anticipated that when non-three-dimensional content is displayed, either transmission is halted or a special transmission is made to signal the eyewear 50A/50B to open both shutters 54/56.

The first waveform 90 C1/C2 represents the signal from the subset of pixels of the television display 7. For exampled, C1 is represented by the subset of pixels being a first color and C2 is represented by the subset of pixels being a second color, for example, C1 is represented by white and C2 is represented by black. Many other representations are anticipated. The second waveform 92 M1/M2 is the output of the modulator 27/37. M1 represents a high value of the synchronization signal while M2 represents a low value of the synchronization signal. As an example, M1 is represented by an infrared light output modulated at 100 Khz and M2 is the infrared light output modulated at 125 Khz. Many representations of the synchronization signal are anticipated.

The third waveform 94 R1/R2 represents the received synchronization signal at the eyewear 50A/50B and the fourth waveform 96 Q/−Q represents control signals to the left and right shutter, respectively. In this example, the left shutter is open and the right shutter is closed when Q is zero (−Q is one). At each leading edge of the synchronization signal, Q/−Q is reversed, thereby opening the shutter 54/56 for the other eye. When reception of the synchronization signal is lost as indicated by a suspension of R1/R2, the internal timing circuit 55 (e.g. phase locked loop) attempts to continue the timing of the shutters 54/56 based on an internal clock such as a crystal-controlled oscillator. Since the internal clock does not accurately track the synchronization signal, the internal timing eventually drifts slightly until reception of the synchronization signal restarts, at which time the internal timing circuit again locks to the received synchronization signal. The loss of the received synchronization signal occurs when, for example, the light transmission is blocked or the radio frequency transmission is scrambled by interference.

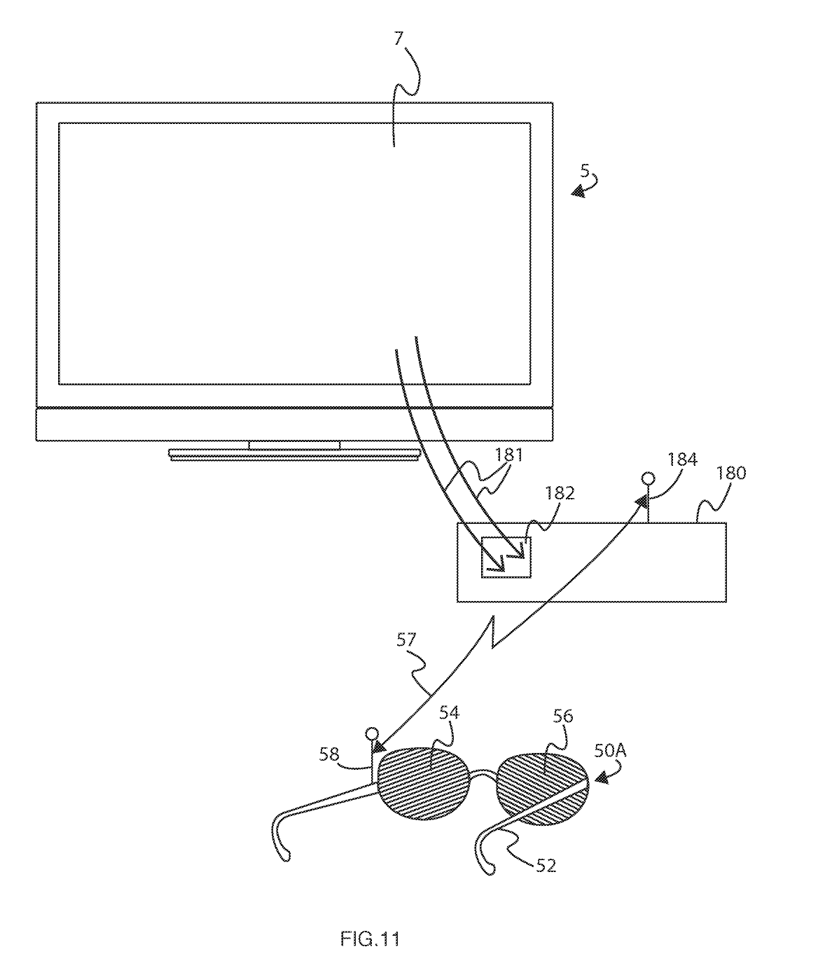

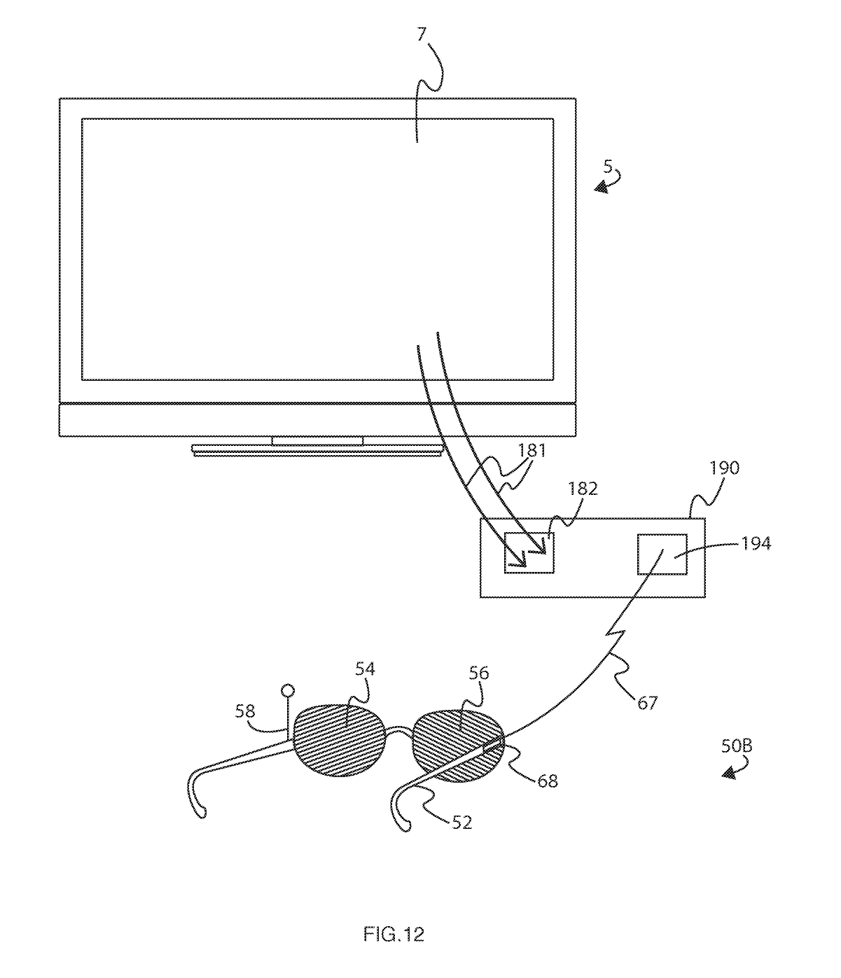

Referring to FIGS. 11-12, a block diagram of a third and fourth embodiments are described. In this, the display 7 of the standard television 7 periodically emits a light synchronization signal 181 that is received by a light detector 182 that is part of synchronization detector 180/190. The synchronization signal is any alteration of the display 7 output such as a white frame followed by a black frame followed by a white frame. In some embodiments when the television systems 5 uses a scanning technique (e.g. cathode-ray tube television systems 5), the synchronization signal is a certain sequence of pixel brightness. For example, B represents a black pixel, W represents a white pixel, and one possible sequence is BWBWWBWB. It is preferred that the light synchronization signal 182 is rarely a normal part of any typical television viewing (e.g., the sequence would not normally appear as a feature of any particular content), so as to not produce false synchronization signals. In some embodiments, the light detector 182 is a camera 182 (e.g. CCD camera) and the light detector 182 detects a pattern within a frame such as a pre-determined geometric pattern.

The synchronization detector 180/190 relays the detected synchronization signal to the eyewear 50A/50B (see FIGS. 2 and 3) either by a radio frequency signal 57 (FIG. 11) or a light wave signal 67 (FIG. 12). The radio frequency signal 57 is emitted on an antenna 184 (either internal or external) and received at the eyewear 50A at an antennal 58. If a light wave 67 is used, the light wave 67 is emitted by a light output device 194 (e.g., LED) and received at the eyewear 50B by a light detector 68 (e.g. photodiode 68). The eyewear 50A/50B then operates as previously described.

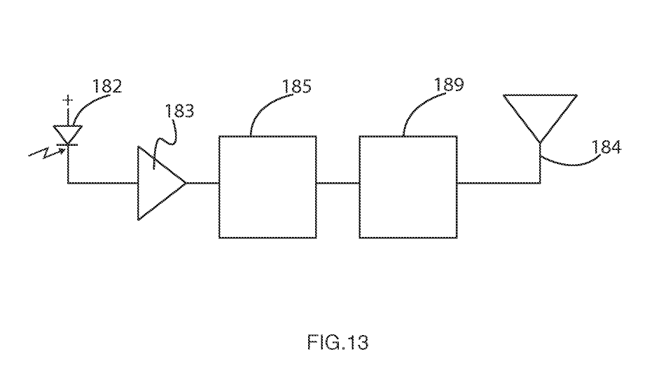

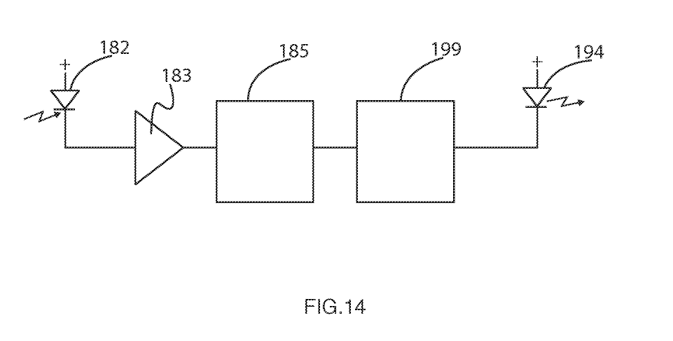

Referring to FIGS. 13 and 14, schematic diagrams of the third and fourth embodiments are described. The light synchronization signal 181 is received by a light detector 182 (e.g. photo diode or camera) of the synchronization detector 180/190. The light synchronization signal 181 is any alteration of the display 7 output as described above. The output of the light detector 182 is, optionally amplified by amplifier 183 and then is detected by a detector 185. The detector 185 looks for the display output fluctuation that indicates synchronization such as a white-frame, black-frame then white-frame sequence. The detector 185 relays the detected signal to a radio frequency modulator 189 (as in FIG. 13) or a light modulator 199 (as in FIG. 14) for transmission to the eyewear 50A/50B. The radio frequency modulator 189 outputs a radio frequency signal onto an antenna 184 as known in the industry. The light modulator 199 drives an output device 194 such as a light emitting diode 194, preferably an LED 194 that emits invisible light such as infrared light.

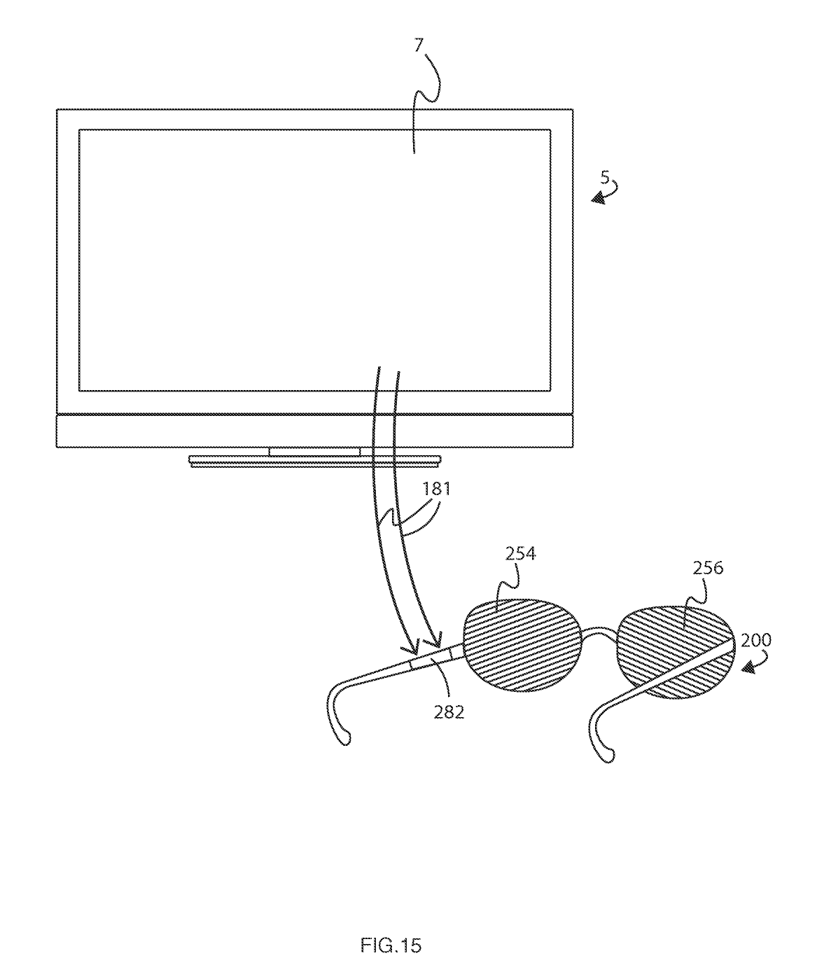

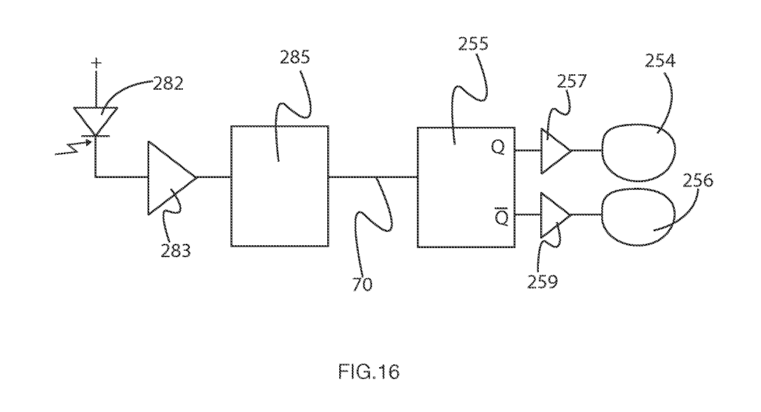

Referring to FIGS. 15 and 16, a block diagram and schematic diagram of the fifth embodiment is described. In this, the display 7 of the standard television 7 periodically emits a light synchronization signal 181 that is received by a light detector 282 that is part of the three-dimensional eyewear 200. The light synchronization signal is as before any alteration of the display 7 output such as a white frame followed by a black frame followed by a white frame. In some embodiments when the television systems 5 uses a scanning technique (e.g. cathode-ray tube television systems 5), the light synchronization signal is a certain sequence of pixel brightness. For example, B represents a black pixel, W represents a white pixel, and one possible sequence is BBWWBBWWBBWWBB. It is preferred that the light synchronization signal is rarely a normal part of any typical television viewing (e.g., the sequence would not normally appear as a feature of any particular content), so as to not produce false light synchronization signals 181.

The light synchronization signal 181 is converted to an electrical signal by the light detector 282 (photo diode, camera, etc) and, optionally, amplified by an amplifier 283 then presented to a detector 285. The detector 285 looks for the sequence of alteration of display output and develops a synchronization signal 70. The synchronization signal 70 is fed to the timing circuit 255 which uses the synchronization signal 70 to control the shutters 254/256 through, for example, shutter drivers 257/259. In the preferred embodiment, the timing circuit 255 includes a phase-locked-loop for continued operation of the shutters 254/256 during loss of the light synchronization signal 181.

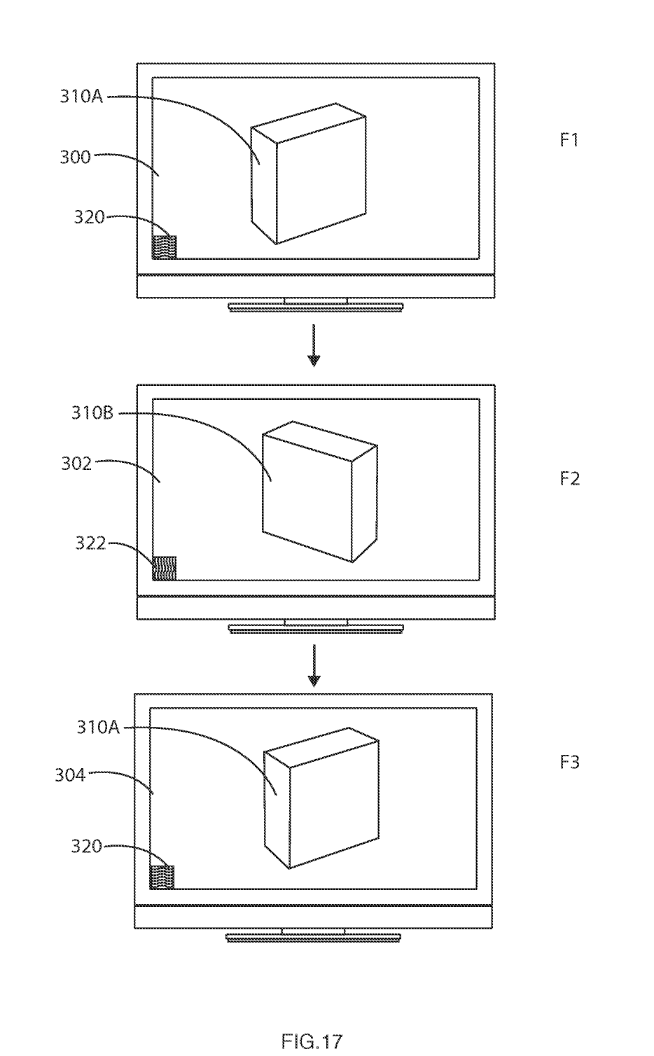

Referring to FIG. 17, a sequence of displayed frames according to a first transmission arrangement is described. This is an exaggeration of what the left eye (frames F1 and F3) and the right eye (frame F2) sees from a three-dimensional perspective. As depicted, in three-dimensional perception, the left eye sees the left side of the box 310A and the right eye sees the right side of the box 310B. In a true video transmission, the viewing angle would be much less than that in this exaggerated view. When frame F1 300 is displayed, the frame relationship indicator area has a first pattern 320. When frame F2 302 is displayed, the frame relationship indicator area has a second pattern 322. When frame F3 304 is displayed, the frame relationship indicator area has, again, the first pattern 320. The transmitter device 20/30, as described above, is optically coupled to the frame relationship indicator area and detects which pattern (first pattern 320 or second pattern 322) is present and generates the synchronization signal from this detection. As stated, the only requirement is that the first pattern 320 is in some way detectably different from the second pattern 322. For example, the first pattern 320 is a set of pixels in the shape of a ‘V’ colored white and the second pattern 322 is the same set of pixels in the shape of a ‘V’ colored blue. In this example, the detector looks for the color change between white and blue and back to white. To an observer, the frame relationship indicator area appears, in this example, as a light-blue ‘V’. Note, only three frames 300/302/304 are shown from a sequence of many. Also note that, although two distinct patterns 320/322 are used in this example, it is anticipated that additional patterns/color changes are used for other synchronization purposes. For example, a first pattern 320 is a red ‘V’ indicating left-eye content is being displayed (e.g. open the left eye shutter) and the second pattern 322 is a blue ‘V’ indicating right-eye content is being displayed (e.g. open the right eye shutter) and a third pattern (not shown) is a purple ‘V’ (red+blue) indicating that two dimensional frames are being displayed, or both-eye content (e.g. open both the left eye shutter and the right eye shutter).

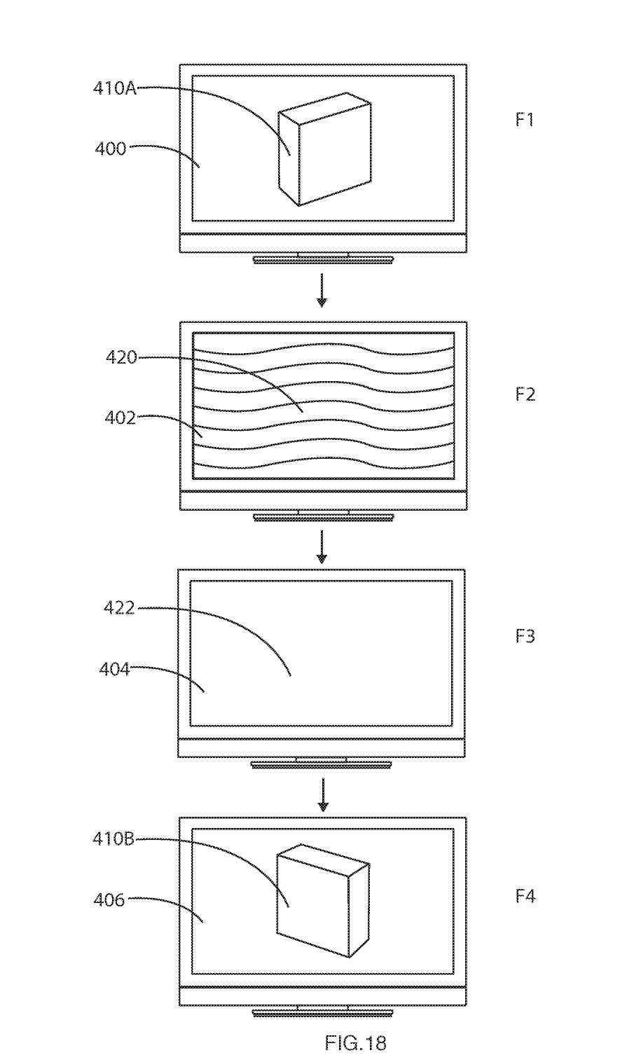

Referring to FIG. 18, a sequence of displayed frames according to a second transmission arrangement is described. In this example, the change from left-eye frames 400 to right eye frames 406 is signaled by right eye marker frames 402/404. The frame depictions are an exaggeration of what the left eye (frame F1) and the right eye (frame F4) sees from a three-dimensional perspective. As depicted, in three-dimensional perception, the left eye sees the left side of the box 410A and the right eye sees the right side of the box 410B. In a true video transmission, the viewing angle would be much less than that in this exaggerated view. Also, in a true display of video, there would be many more frames displayed in sequence.

The sequence includes content frames F1 400 and F4 406 and marker sets F2 402 and F3 404. The marker sets 402/404 consist of one or more frames. For example, a marker set includes two frames displayed for one frame-time each (e.g. 33 milliseconds per frame at a 30 frames per second rate). The content of the marker sets 402/404 vary enough to be detectable by the detection circuit 185/285 but are preferably not easily detected by the human eye. In one example, the marker set includes a first marker frame 402 that is an all-black frame (all black pixels) and the second marker frame 404 is an all-white frame (all white pixels). In another example, the first marker frame 402 is a slightly dimmer copy of the left-eye content frame 400 and the second signaling frame is a slightly brighter left-eye content frame 400, thereby reducing any noticeable content modification. Although two signaling frames 402/404 are shown, any number is anticipated. For example, to switch from a left-eye frame 400 to a right-eye frame 406, the right-eye marker set displayed is a single brighter left-eye frame. The right-eye marker is displayed before the right-eye content frame 406. The detector 185/285 then detects the increase in brightness to open the right shutter 256 and close the left shutter 254. To switch from a right-eye view 406 to the left-eye view 400, a left-eye marker set is displayed and in this example, the left-eye marker set is a single dimmer right-eye frame. The detector 185/285 then detects the decrease in brightness to open the left shutter 254 and close the right shutter 256. Therefore, the detector 185/285 detects the brightness increase to synchronize the opening of the right shutter and closing of the left shutter and the detector 185/285 detects the brightness decrease to synchronize the opening of the left shutter and closing of the right shutter. For content that is for both eyes, a both-eye marker set is used. For example, a both-eye marker set occurs before one or more frames that are not in three-dimensions. The both-eye marker set is detectably different from the left-eye marker set and detectably different from the right-eye marker set. For example, the both-eye marker set includes three sequential frames, the first and third frames being black frames 402 and the intermediate frame being white 404. There are many examples of detectably different frames and detectably different sequences of frames or frame sets. In embodiments in which the detector includes a camera, the camera detects a pattern of pixels and therefore, each marker set has a single frame containing a distinguishable set of pixels such as icons or other sets of pixels.

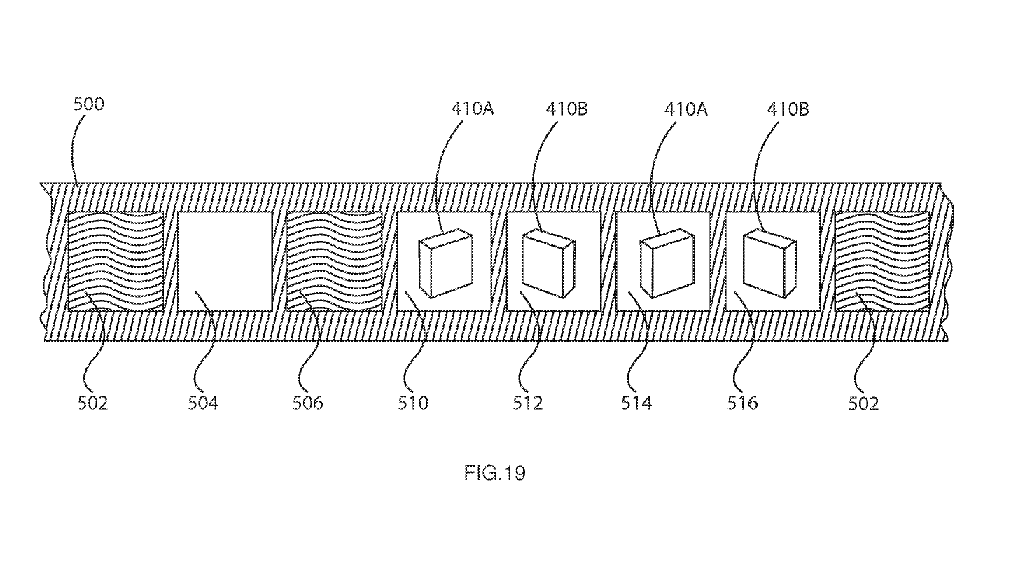

Referring to FIG. 19, an exemplary sequence of displayed frames according to a second transmission arrangement is described. In this example, a synchronization sequence of one or more marker frames, in this example three marker frames 502/504/506, is followed by a sequence of left and right content frames 510/512/514/516 on a digital media 500 (e.g. DVD disk, Blueray disk, hard disk, memory, etc). The start of the next sequence is shown by the first marker frame 502 of the next sequence. The marker frames 502/504/506 indicate the start of a sequence of content 510/512/514/516. Although the synchronization sequence is any number of marker frames including one marker frame, the example of FIG. 19 shows three marker frames 502/504/506. As an example, the first 502 and third 506 marker frames have the same set of pixel values and the second marker frame 504 has a distinguishably different set of pixels. The sequence of left and right content frames 510/512/514/516 is of any predetermined sequence and length, four frames in length in this example. The detector 185/285 detects the marker frames 502/504/506 and measures the duration of the marker frames 502/504/506 to generate a synchronization signal. For example, by locking onto the time of first detecting (leading edge) each of the marker frames 502/504/506, a synchronization signal is determined that predicts when each transition between, for example, left-eye content frames 510/514 and right-eye content frames 512/516 will occur and, thereby, the shutters 54/254/56/256 are controlled to synchronize with the display of the corresponding content frame. To reduce drift caused by slight variations between clocks, synchronization sequences 502/504/506 are embedded in the three-dimensional content at fixed positions. In such, the receiver knows to expect a synchronization sequence 502/504/506 followed by a pre-determined sequence of left-eye content frames 510/514, right-eye content frames 512/516, followed by another synchronization sequence 502/504/506, etc. In examples in which the synchronization sequence is one marker frame, the detector determines the start of the marker frame and the duration of the marker frame. From that, it knows that the first content frame (e.g. left-eye content frame 510) follows immediately after the marker frame and then exactly one duration later is a second content frame (e.g. right-eye content frame 512), etc.

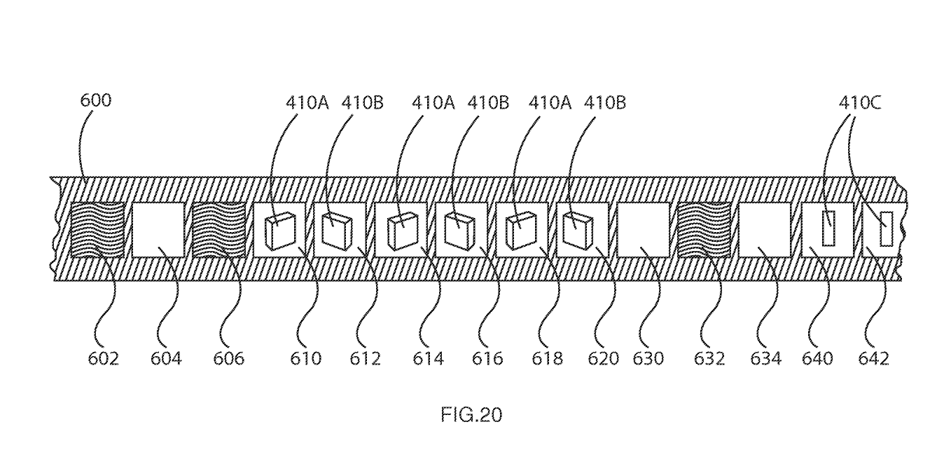

Referring to FIG. 20, a second exemplary sequence of displayed frames according to a second transmission arrangement is described. In this example, a three-dimensional synchronization sequence 602/604/606 of one or more marker frames, in this example three marker frames 602/604/606, is followed by a sequence of left and right content frames 610/612/614/616/618/620 on a digital media 600 (e.g. DVD disk, Blueray disk, hard disk, memory, etc). After the three-dimensional content frames 610/612/614/616/618/620, the content is two-dimensional (e.g. both shutters 54/254/56/256 are open). The start of the two-dimensional, both-eye content frames is indicated by a different synchronization sequence 630/632/634 shown in this example by the second marker frame 630, followed by the first marker frame 632 followed by the second marker frame 634. The synchronization sequence 630/632/634 (marker frames 630/632/634) indicate a start of a sequence of both-eye content frames 640/642, etc 410C. Since there is no shutter operation during two-dimensional or both-eye content frames, there is no need to include further two-dimensional synchronization sequence 630/632/634, although additional two-dimensional synchronization sequence 630/632/634 are anticipated in case the first sequence is lost due to interference.

Although the two-dimensional synchronization sequence 630/632/634 and three-dimensional synchronization sequence 602/604/606 is any number of marker frames including one marker frame, the example of FIG. 20 shows three marker frames. As an example, in the three-dimensional synchronization sequence 602/604/606, the first 602 and third 606 marker frames have the same set of pixel values and the second marker frame 604 has a distinguishably different set of pixels. Similarly, in the two-dimensional synchronization sequence 630/632/634, the first 630 and third 634 marker frames have the same set of pixel values and the second marker frame 632 has a detectably distinguishably different set of pixels and also being detectably distinguishable from the three-dimensional synchronization sequence 602/604/606.

The sequence of left and right content frames 610/612/614/616/618/620 is of any predetermined sequence and length, six frames in length in this example. The detector 185/285 detects the three-dimensional marker frames 602/604/606 and measures the duration of the marker frames 602/604/606 to generate a synchronization signal. For example, by locking onto the time of first detecting (leading edge) each of the marker frames 602/604/606, a synchronization signal is determined that predicts when each transition between, for example, left-eye content frames 610/614/618 and right-eye content frames 612/616/620 will occur and, thereby, the shutters 54/254/56/256 are controlled to synchronize with the display of the corresponding content frame. To reduce drift caused by slight variations between clocks, synchronization sequences 602/604/606 are embedded in the three-dimensional content at fixed positions. In such, the receiver knows to expect a synchronization sequence 602/604/606 followed by a pre-determined sequence of left-eye content frames 610/614/618, right-eye content frames 612/616/620, followed by another synchronization sequence 602/604/606 (or a two-dimensional synchronization sequence 630/632/634), etc.

Equivalent elements can be substituted for the ones set forth above such that they perform in substantially the same manner in substantially the same way for achieving substantially the same result.

It is believed that the system and method and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A method for encoding three-dimensional digital video content, the method comprising:
reserving a subset of pixels of each digital video frame;
encoding the subset of pixels with a first pattern of pixel values representing left-eye frames, the left eye frames containing left-eye content; and
encoding the subset of pixels with a second pattern of pixel values representing right-eye frames, the right-eye frames containing right-eye content.

2. The method of claim 1, wherein in the first pattern of pixel values, the subset of pixels values is of a first color.

3. The method of claim 2, wherein in the second pattern of pixel values, the subset of pixels values is of a second color and the first color is different than the second color.

4. The method of claim 1, wherein the first pattern of pixel values includes a sequence of pixel values.

5. The method of claim 4, wherein the second pattern of pixel values includes a second sequence of pixel values and the first sequence of pixel values differs from the second sequence of pixel values in a way that is detectable by an image sensor.

6. The method of claim 1, wherein the method further includes the step of:
encoding the subset of pixels with a different pattern than either of the first pattern or second pattern for frames containing both-eye content.

7. A method of encoding digital content with three-dimensional indicators, the method comprising:
(a) reserving a predetermined set of pixels of each frame of the digital content for three-dimensional encoding;
(b) while more frames exist in an input stream:
(c) reading a current frame;
(d) if the current frame is a left-eye frame, encoding the predetermined set of pixels with a first set of pixel values;
(e) if the current frame is a right-eye frame, encoding the predetermined set of pixels with a second set of pixel values, the second set of pixel values being detectably different than the first set of pixel values;
(f) writing the current frame along with the predetermined set of pixels to an output stream.

8. The method of claim 7, further comprising after step (e), the step of:
(e′) if the current frame is a both-eye frame, encoding the predetermined set of pixels with a set of pixel values that is different from the first set of pixels and is different from the second set of pixels.

9. The method of claim 7, wherein the first set of pixel values includes a first set of pixel colors.

10. The method of claim 9, wherein the second set of pixel values includes a second set of pixel colors and the second set of pixel colors is different from the first set of pixel colors.

11. The method of claim 7, wherein the first set of pixel values includes a first sequence of pixel values.

12. The method of claim 11, wherein the second set of pixel values includes a second sequence of pixel values and the first sequence of pixel values differs from the second sequence of pixel values in a way that is detectable by an image sensor.

13. A three-dimensional encoding of digital video content, the three-dimensional encoding comprising:
a sequence of frames stored on a digital media, each frame containing pixels, a subset of pixels of the each frame reserved for encoding;
in left-eye frames of the sequence of frames having left-eye content in the pixels, the subset of pixels is encoded with a first set of pixel values; and
in right-eye frames of the sequence of frames having right-eye content in the pixels, the subset of pixels is encoded with a second set of pixel values;
wherein the first set of pixel values is detectably different than the second set of pixel values.

14. The three-dimensional encoding of digital video content of claim 13, further comprising:
in both-eye frames of the sequence of frames having both-eye content in the pixels, the subset of pixels is encoded with a third set of pixel values that is detectably different from both the first set of pixel values and the second set of pixel values.

15. The three-dimensional encoding of digital video content of claim 13, wherein the first set of pixel values includes a first set of pixel colors.

16. The three-dimensional encoding of digital video content of claim 15, wherein the second set of pixel values includes a second set of pixel colors and the second set of pixel colors is different from the first set of pixel colors.

17. The three-dimensional encoding of digital video content of claim 13, wherein the first set of pixel values includes a first sequence of pixel values.

18. The three-dimensional encoding of digital video content of claim 17, wherein the second set of pixel values includes a second sequence of pixel values and the first sequence of pixel values differs from the second sequence of pixel values in a way that is detectable by an image sensor.

19. The three-dimensional encoding of digital video content of claim 14, wherein the first set of pixel values includes a first set of pixel colors, the second set of pixel values includes a second set of pixel colors, the third set of pixel values includes a third set of pixel colors and the third set of pixel colors is different from the second set of pixel colors, the second set of pixel colors is different from the first set of pixel colors and the third set of pixel colors is different from the first set of pixel colors.

20. The three-dimensional encoding of digital video content of claim 13, wherein the frames are compressed.
